(19) United States
(12) Patent Application Publication
(10) Pub. No.: US 2018/0150972 A1
(43) Pub. Date: May 31, 2018

(54) SYSTEM FOR DETERMINING POSITION OF A ROBOT

(71) Applicant: Jixiang Zhu, Las Vegas, NV (US)

(72) Inventor: Jixiang Zhu, Las Vegas, NV (US)

(21) Appl. No.: 15/826,624

(22) Filed: Nov. 29, 2017

(30) Foreign Application Priority Data
Nov. 30, 2016 (CN) 201611078884.8

(51) Int. Cl. G06T 7/73; G06T 7/246; G05D 1/02

(52) U.S. Cl. CPC G06T 7/74; G06T 7/248; G06T 2207/30241; G06T 2207/10052; G05D 1/0246

(57) ABSTRACT

A method for recognizing the position of a mobile robot by comparing images has the steps of a mobile robot illuminating a shooting area to be photographed using a monochromatic lighting unit, the mobile robot photographing the position image corresponding to the shooting area and a narrow band filter passes only the light emitted by the monochromatic lighting unit with the light having same wavelength emitted from the monochromatic lighting unit, reflective or light absorbing material are randomly placed on the shooting area to increase the contrast ratio, and the mobile robot acquiring the reference image corresponding to the trajectory of the mobile robot from the known position image set, wherein the known position image set corresponds to a predetermined trajectory and the known position image set includes a plurality of reference images. A mobile robot may have monochrome lighting for illuminating a shooting area to be photographed.

### CROSS-REFERENCE TO RELATED APPLICATION(S)

The present application claims priority to Chinese Patent Application number or patent number 201611078884.8 having a Serial number 2017011900770540 filed on Jan. 23, 2017, entitled “By comparing the position of mobile robot with image recognition and mobile robot.”

### BACKGROUND OF THE INVENTION

### 1. Field of Invention

The present invention relates to the field of automation technology and, more particularly, to a method for a mobile robot recognizing its position and self-directing by comparing a current image of its position and a previously-taken reference image provided in an earlier process of determining the route.

### 2. Description of Related Art

With the development of science and technology, industrial automation is a growing field of robotic endeavor. In order to reduce labor costs, the mobile robots are used in many factories or warehouses to carry cargo and so on. The mobile robots, such as forklifts or stocking robots, are typically designed for remote control or automatic control. Therefore people can control their own mobile robots, and specifically control the mobile robots in accordance with the predetermined route to walk, also can follow a predetermined of scheduled route to go up and down the stairs, and even can go across the obstacles and uneven terrains. However, this requires the input of an operator to control the robot.

There are many mobile robots available on the market, and most of these mobile robots are used to carry a variety of goods in warehouses or factories. Under normal circumstances, most of the mobile robots in the warehouses or factories carry goods automatically by following the pre-set routes, that is, following the starting point of the pre-set route to load goods, and then transporting goods to the unloading point by following the pre-set route, and repeating the operations. Typically, a warehouse has a shipping/receiving terminal, and the incoming goods are transported from the terminal to a location on a storage shelf by the robot. The outgoing goods go through the reverse process, and the routes between the terminal and the various storage shelf are fixed, so it makes sense to automate carriage along these routes However, the current selection of mobile robots requires a complex installation process and the costs are high, which limits the application of mobile robots.

Based on the foregoing, there is a need in the art for a method of a mobile robot recognizing its position by comparing a current image with reference images of the route, while providing a high stability, a simple installation procedure and a low design cost, to result in a greatly improved user experience.

### SUMMARY OF THE INVENTION

The technical problem that the present invention mainly solves is to provide a method for recognizing the position of the mobile robot by comparing a reference image taken previously on a reference route, with a current image taken by the robot. The images are compared and the robot may adjust its position accordingly, to remain on the route. The stability is high, the installation procedure is simple and the design cost is low, in contrast with prior art robot route-finding, with the result that the user experience is greatly improved.

A pre-determined route or trajectory is recorded by a plurality of reference images, taken from the position that the robot should be occupying, by a robot having a “perfect route”, namely a human-operator controlled run-through. In order to solve the above-noted technical problem, a method for recognizing a position of a mobile robot by comparing images is provided, including the steps of: i) a mobile robot illuminating a shooting area to be photographed using a monochromatic lighting unit; ii) the mobile robot photographing the position image corresponding to the shooting area by using a narrow band filter on the lens of the camera to permit only the monochromatic light to enter the camera; and iii) the mobile robot comparing the position image to one or more reference images, taken previously by a human operator or other standard operating procedure, iv) determining an offset by comparing the position image to one or more of the reference image(s), overlapping the position image with the reference image. When the current image overlaps with the reference image, the overlap in X- or Y-direction, or rotation, an offset may be determined, and v) the mobile robot changing its trajectory to reduce the offset between the position image and the reference image(s).

A mobile robot apparatus is also provided, which may be used for carrying out the method, the apparatus having: a monochrome lighting module for illuminating a shooting area to be photographed; a camera module for capturing a corresponding position image, in which a lens of the camera module is provided with a narrow band filter for passing light emitted by the lighting module and the light of a corresponding wavelength emitted by the lighting module; an image acquisition module for acquiring a reference image corresponding to the trajectory of the mobile robot from a known position image set, wherein the known position image set corresponds to a predetermined trajectory and a microprocessor with memory containing a plurality of reference images. The predetermined trajectory is determined from a series of reference images, which indicate the correct path or action for the robot to take in connection with comparison of the reference images with the positions images taken by the robot. A processing module compares the position image with the reference image and determines an offset and orientation of the position image, typically based on how the image overlaps with the image in the same or similar area of the reference image. The mobile robot, as determined by one or more processors in the robot, will best-fit a match of the part of the image that is identical to that of the reference image so the offset in X and Y direction (of an x-y coordinate system) and a corresponding angle therebetween are obtained. The robot will use this information to determine how the trajectory or position should change. Remedial movement by the robot may be undertaken to remedy the position differential, and get “back on track”. Further images may be compared to ensure the remedial movement has had the right effect.

The beneficial effects derived includes recognition of the position of the mobile robot in connection with comparing images. In some embodiment i) a mobile robot illuminates a shooting area to be photographed using a monochromatic lighting unit; ii) the mobile robot photographs the position image corresponding to the shooting area in connection with a narrow band filter, used with a lens of the camera, for passing monochromatic light emitted by a monochromatic lighting unit; and iii) the mobile robot comparing the position image with a reference image corresponding to an expected or anticipated trajectory of the mobile robot from the known position image set, to determine an offset which the robot may use to change its position and direction.

In some embodiments, in order to improve the contrast, or signal-to-noise ratio, associated with the position image, light reflecting tape is placed on the ceiling (of a space in which the robot operates), to reflect light emitted by the lighting unit so as to cause a greater amount of light to be received by the camera from the light-reflecting tape, and the bright areas on a reference photo being matched to the bright areas on a position photo.

The predetermined trajectory is determined by a number of reference images, taken at some previous point in time, properly representing the path or action that the robot is supposed to take. The reference images are taken at a perspective of the robot, wherein the distance from the robot as the photo taker, and the subject of the image, typically a ceiling pattern or a path for the robot. In some embodiments, a remote-controlled robot is driven along the route by a human operator, to produce a reference route, and photos are taken from the robot along the course of that route to provide the reference images. The reference images may be taken in visible light or light of non-visible wavelengths. Increased contrast provides more accurate comparison between the position image and reference image. A method of increasing contrasts of the images is provided that includes depositing reflective or light-absorbing material, along the route thereby increasing the signal-to-noise ratio associated with the images. The method of identifying the position of the mobile robot by contrasting images will not be influenced by the light when the mobile robot is moved, and the installation program is simple: namely, randomly attaching the reflective tape to a wall or ceiling surface to provide a reference for the route. A low design cost is low, thus facilitating the development of the mobile robot, and greatly improving the stability of the mobile robot and effectively enhance the user experience.

The foregoing, and other features and advantages thereof, will be apparent from the following, more particular description of the embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a flow chart of a method for identifying the position of a mobile robot by comparing images, according to an embodiment of the present invention;

FIG. 2 is a schematic diagram of the position image of the present invention vs. reference image, according to an embodiment of the present invention;

FIG. 3 is a schematic diagram of position image vs. reference image after adjustment, according to an embodiment of the present invention;

FIG. 4 is a structural diagram of a mobile robot, according to an embodiment of the invention;

FIG. 5 is a schematic diagram of the processing module of FIG. 4, according to an embodiment of the invention; and

FIG. 6 is a schematic structural view of the calculation module in FIG. 4, according to an embodiment of the invention.

FIG. 7 is an image of a robot having the navigation control, according to an embodiment of the invention.

FIG. 8 is a detail view of the navigation control, according to an embodiment of the invention.

FIG. 9 is a detail view of the reflective tape, according to an embodiment of the invention.

FIGS. 10a-10b are views of reflective tape on a ceiling in visible light, and high-contrast monochrome light, according to an embodiment of the invention.

### DETAILED DESCRIPTION OF PREFERRED EMBODIMENTS

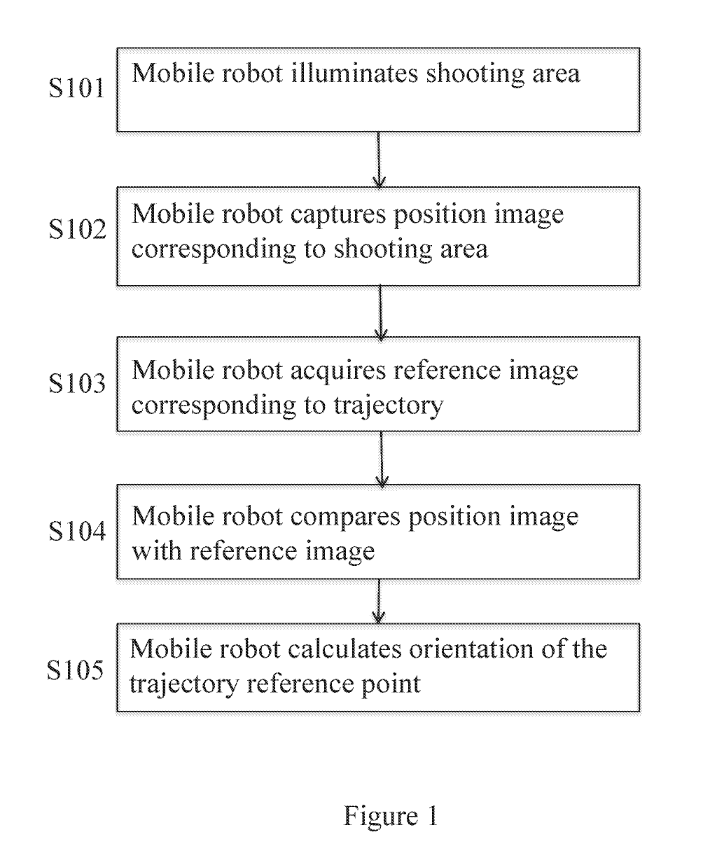

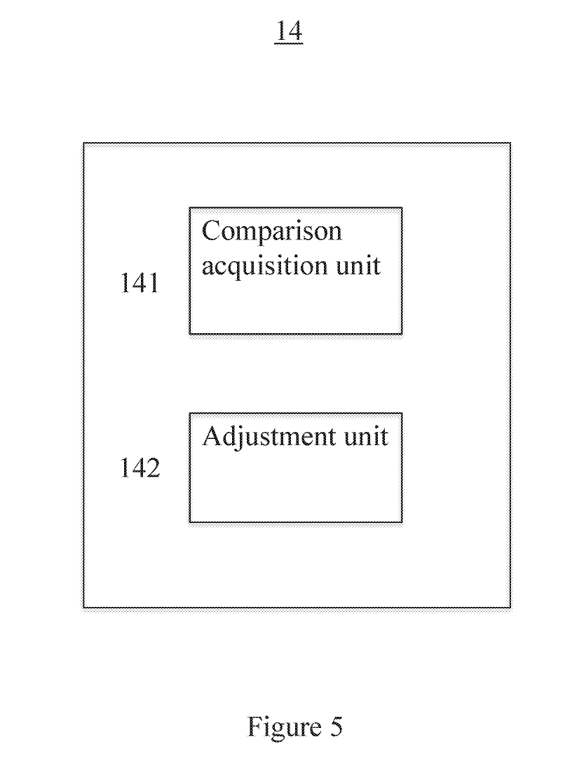

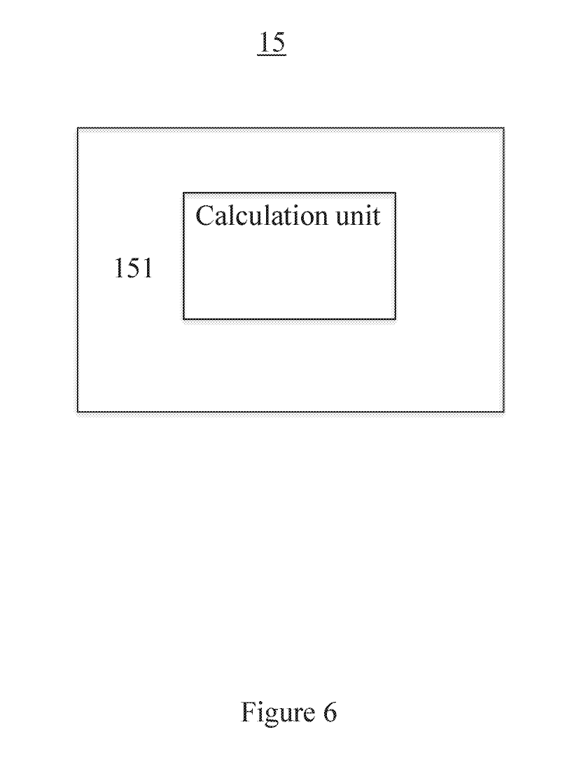

Preferred embodiments of the present invention and their advantages may be understood by referring to FIGS. 1-10b, wherein like reference numerals refer to like elements.

The present invention describes a method of a robot recognizing its position by comparing one or more images from its current location to one or more reference images showing a view from the ideal path, including i) a mobile robot illuminating a shooting area to be photographed using a monochromatic lighting unit; ii) the mobile robot capturing the position image corresponding to the shooting area through a camera; iii) the mobile robot comparing the position image with one or more reference images corresponding to the trajectory or position of the mobile robot; iv) the mobile robot determining an offset between the position image and the reference image by comparison of the images through identifying overlapping portions of the position and reference images; and v) the mobile robot matching the part of the position image that is identical to that of the reference image so the offset in X, Y, position (on an x-y coordinate system) and the angle therebetween are obtained. In the above-described manner, the mobile robot described in the present invention has higher stability, simplified installation procedure and lower design cost, overall, over existing systems, all of which may contribute greatly towards improving the user experience.

The present invention is described in detail with reference to the accompanying drawings and the implementation mode. In FIG. 1 a flow chart of a method for identifying the position of a mobile robot by comparing images is shown. The method comprises the following steps:

Step S101: The mobile robot illuminates the shooting area with monochromatic lights, using a monochrome lighting unit. In an embodiment, the monochrome lighting unit may emit a monochromatic light to illuminate a shooting area to be photographed so that the brightness of the shooting area to be photographed may be enhanced. More importantly, the monochromatic lighting unit include a monochromatic light emitting diode (e.g., red or green light emitting diode) or an infrared emitter, such that the camera is able to focus on the same monochromatic frequency and eliminate other information (noise) in other wavelengths. This reduces noise for a better signal and reduces the cost of the sensor and processing. The present invention is not limited to monochromatic lighting units that may specifically include monochromatic light emitting diodes or infrared emitters. In other examples, the monochromatic lighting units may be other non-monochromatic light-emitting devices. The use of non-monochromatic light requires further processing to avoid errors yet is within the scope of the invention. The shooting area may be a ceiling area, wall area or any area identifying the location of the robot.

Before commencing step S101, the method may have the additional steps of the mobile robot storing a known reference image set corresponding to a predetermined trajectory, in a memory, wherein the known reference image set corresponds to a predetermined trajectory, and the known reference image set including a plurality of reference images. The plurality of reference images may be taken from the same position as the robot, by a reference run of the robot, or a human operator operating a vehicle like the robot, such as the robot's perspective is maintained in the reference images, such that subsequent comparison of the position images results in a more accurate comparison. In some embodiments, the mobile robot has a learning function, and the trajectory route can be recorded in connection with known position images. It is to be understood that the mobile robot of the present invention is suitable for indoor or outdoor scenes with a ceiling or wall, or some surface to image and compare.

Step S102: The mobile robot captures the position image corresponding to the shooting area, usually a ceiling or floor that is marked for reference, using the camera. In one embodiment, a narrow-band filter is provided on the lens of the camera, and more specifically, a dismountable narrow-band filter is provided at a predetermined distance from the lens of the camera. The narrow band filter is used for only passing light emitted by the monochromatic lighting unit and it passes light within the same or similar wavelength of the light emitted by the monochromatic lighting unit, to emphasize the monochromatic light and reduce the other information in the image information The filter is matched to the monochromatic lighting. In other words, through the narrow band filter filtering out the majority of the light captured by the camera, the effects of strong light or other light on the camera can be effectively solved and the quality of the image backlighting can be greatly improved.

Step S103: The mobile robot receives the appropriate or closest reference image corresponding to the trajectory of the mobile robot from the known reference image set based on the encoder (odometer) reading on the robot. The trajectory reference point corresponding to the reference image(s) is preferably the closest to the shooting area corresponding to the position image. That is, the trajectory reference point is closest to the current shooting area.

Step S104: The mobile robot compares the position image with the reference image and adjusts the position image based on the comparison result so that the position image is overlapped with the image shown in same area in the reference image. In an embodiment, Step S104 includes the substeps of

104A: The mobile robot comparing the position image with the reference image to obtain the same area as the reference image and the reference image; and
104B. The mobile robot moving and rotating the position image with the trajectory reference point corresponding to the reference image as an origin so that the image in the same area of the position image overlaps with the image in the same area of the reference image.

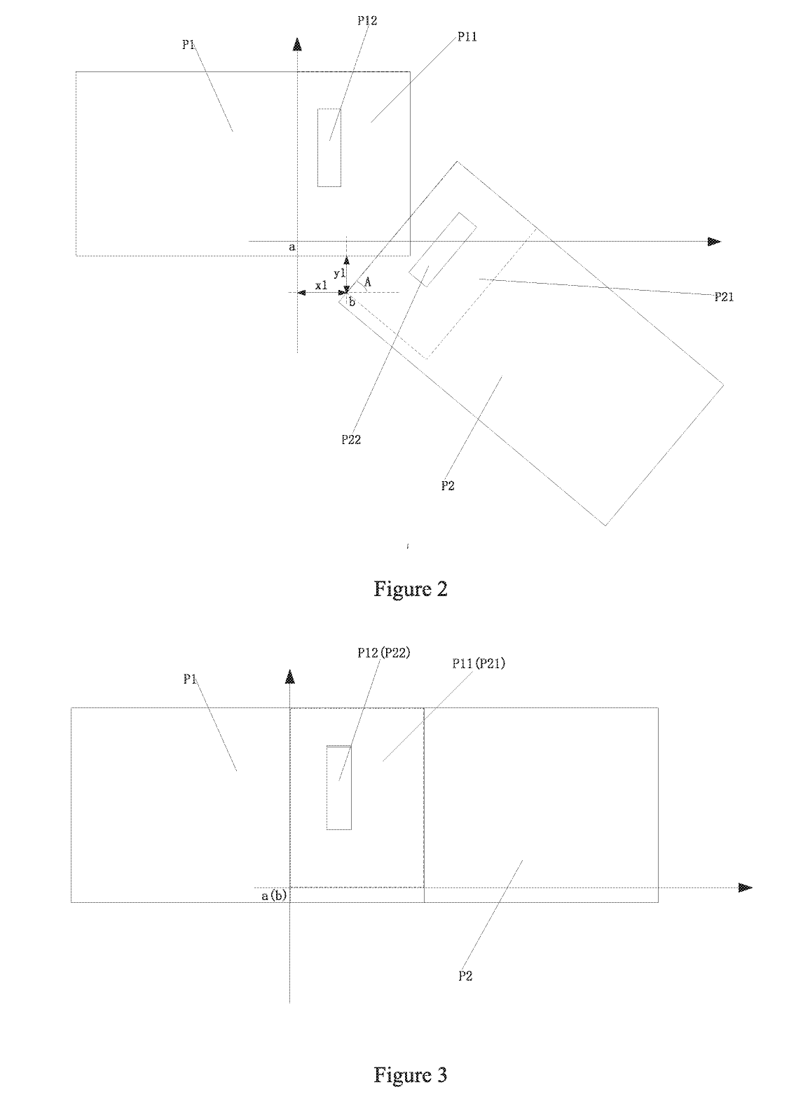

As illustrated by the example of FIG. 2, the mobile robot compares the position image P2 with the reference image P1 and acquires the same areas P11 and P21 of the position image P2 and the reference image P1, respectively based on the comparison result. At the same time, the mobile robot finds that the image P22 of the same area P21 in the position image P2 is the same as the image P12 of the same area P11 in the reference image P1. Therefore, the mobile robot establishes the x-axis and y-axis coordinates by taking the track reference point corresponding to the reference image P1 as the origin. The track reference point corresponding to the reference image P1 may be an arbitrary position on the same area P11 of the reference image P1. This example takes the lower left endpoint of the reference image P1 as the trajectory reference point. At the same time, the mobile robot takes the arbitrary position on the same area P21 of the position image P2 as the mobile point b, and the mobile point b corresponds to the origin a on the same area, that is, the lower left corner of the position image P2 of the example is taken as the mobile point b, and the mobile point b is moved towards the direction of the origin a, that is, the position image P2 moves along the y-axis according to the mobile point b by the distance y1, and the position image P2 is moved along the mobile point b along the x-axis by the distance x1, and the position image P2 is rotated by angle A in the counterclockwise direction in accordance with the moving point b so that the image P22 of the same area P21 in the position image P2 overlaps with the image P12 in the same area P11 of the reference image P1 as shown in FIG. 3. The adjustment of the position image P2 described moves the position image P2 while the position image P2 is compared with the reference image P1 to determine whether the images in the same area of the position image and the reference image overlap with each other. When the mobile robot judges whether the images in the same area of the reference image overlap with each other, the position image is compared with the reference image when the coincidence degree of the image in the same area of the position image and the reference image reaches a predetermined value, the images in the same area of the image overlap with each other, where the predetermined value is a value set by the user, such as more than 50% or 80%, depending on the actual situation.

Step S105: The mobile robot calculates an offset of its position image and the reference image, to produce a position deflection that is used by the robot to alter its position to a position more closely match the reference image. The orientation of the trajectory reference point corresponding to the reference image corresponding to the position image to determine the trajectory position of the mobile robot. In an embodiment, in step S105 the mobile robot calculates the distance x1 of the x-axis and the distance y1 of the y-axis of the three-dimensional coordinate established at origin a relative to the position image P2, and the angle A at which the position image P2 is relative to the origin a. Thusly, the orientation of the trajectory reference point corresponding to the reference image P1 is obtained for the shooting area corresponding to the position image P2. That is, the mobile robot automatically calculates the x-axis distance, the y-axis distance, and the angle of rotation of the position image P2.

The steps following step S105 includes step 105b, wherein the mobile robot judges whether the orientation of the trajectory reference point corresponding to the reference image is within the valid range of the shooting area corresponding to the position image. If not, the mobile robot moves to change the position of the trajectory reference point corresponding to the reference image so that the orientation of the trajectory reference point corresponds to the reference image within the valid range of the shooting area corresponding to the position image. If so, the mobile robot continues to move to the next position and proceeds to step S101. That is, the mobile robot judges whether the shooting area corresponding to the position image deviates from the predetermined trajectory of the trajectory reference point corresponding to the reference image. If so, the mobile robot automatically moves back to the preset trajectory so that the position image corresponding to the shooting area does not deviate from the predetermined trajectory of the trajectory reference point corresponding to the reference image.

In some embodiments, a reflective material or a light-absorbing material is provided in a region where the contrast ratio is relatively small in the shooting area corresponding to the predetermined trajectory. That is, a reflective material or a light-absorbing material may be provided on the ceiling of a route path so that the reflective material or the light-absorbing material can be installed in a region where the contrast of the predetermined track is not obvious to improve the contrast of the image. Specifically, it is possible to install the reflective material (such as reflective films, reflectors, reflective tape or white paints) in a relatively dark area of the ceiling, or to install the light-absorbing material (such black papers, black tapes or black paints, preferably matte) in a relatively bright area of the ceiling. This method of contrast enhancement increases the signal-to-noise ratio and decreases errors in photo comparison, and the reflective material or light-absorbing material may also be present in the reference images at the same location to reduce confusion.

The major problem in visual navigation is due to the change of the light conditions throughout the day. In an indoor environment, light sources may range from indirect daylight during the day and electric lights (incandescent or fluorescent) at night. The light conditions (intensity, color etc.) may also vary greatly depending on the time of day. This variation in light condition causes the images taken at different times to appear vastly different, making the matching nearly impossible under certain circumstances.

Accordingly, to improve the signal to noise ratio, the wavelength of the narrow band filter is chosen to be where room light specific energy density (energy/unit wavelength) is low. This may often be in a visible spectrum that is outside of the range of visible light, as room lighting is designed not to emit such frequencies to conserve energy. In an embodiment, an infrared wavelength such as 850 nm is preferred because of the easy availability of the sensor and the light source in this wavelength. Other low emission wavelength may be chosen as well. This approach decreases the noise due to the change of the room light, and in an embodiment, to increase the signal, the wavelength of the light source (LED) mounted near the camera is also at the same 850 nm. This brings about stability in the lighting conditions.

In one embodiment, reflective tape, such as that made by 3M™, reflects the light along the direction of the incident light, further increasing the signal to noise ratio. Because the camera and the lighting unit are mounted together, the camera sees the largest signal from the tape (generally in a perpendicular plane) as the light is reflected directly back to the camera. This ensures that some changes in the ceiling condition such as the presence of a ceiling fan and/or hanging car can be tolerated with a continually reliable operation.

In some examples, the lens of the camera is provided with a narrow-band filter for converting light emitted by the monochromatic lighting unit and the light with the same wavelength as the light emitted from the monochromatic lighting unit, and the camera will not be affected by the strong light or other light and the camera's shooting quality is greatly improved. At the same time, a reflective material or a light-absorbing material is provided in the shooting area corresponding to the predetermined trajectory so that the contrast of the image captured by the camera can be effectively improved.

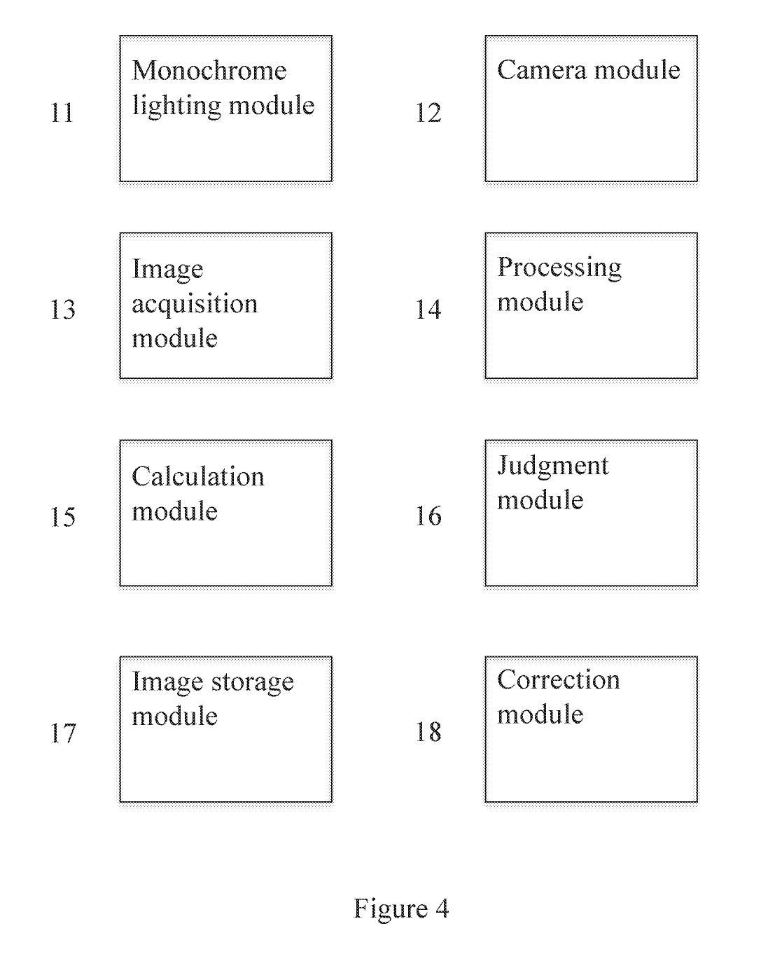

FIG. 4 shows a structural schematic of the mobile robot described in the present invention.

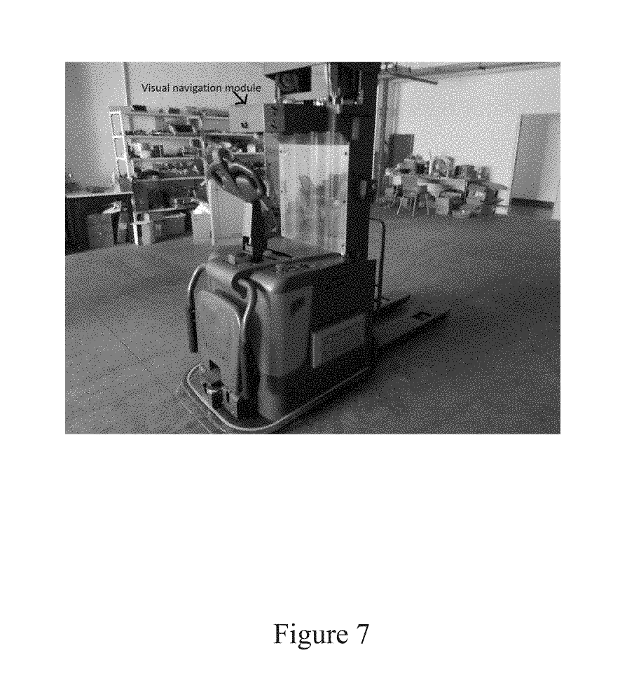

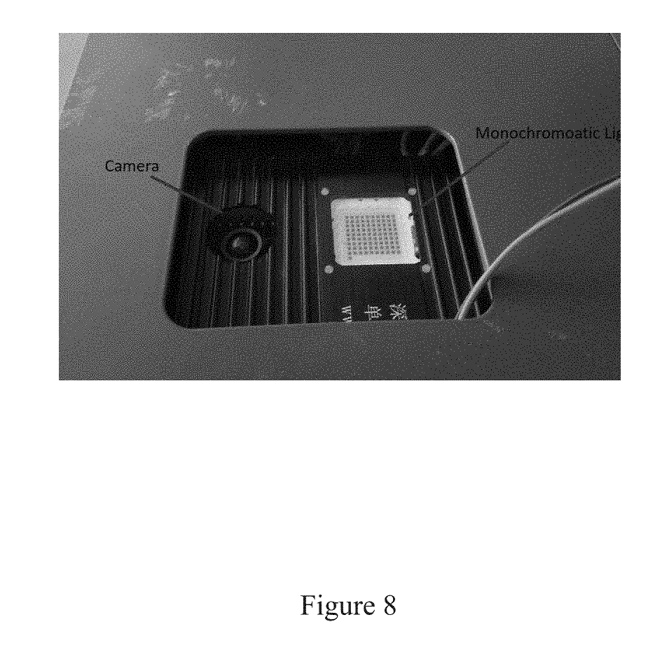

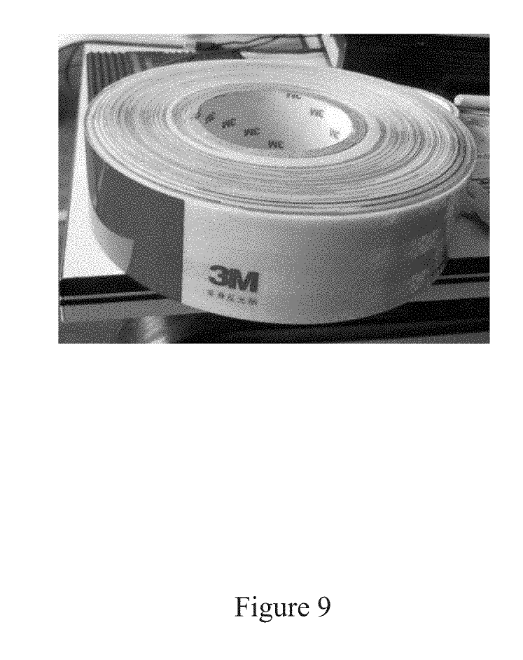

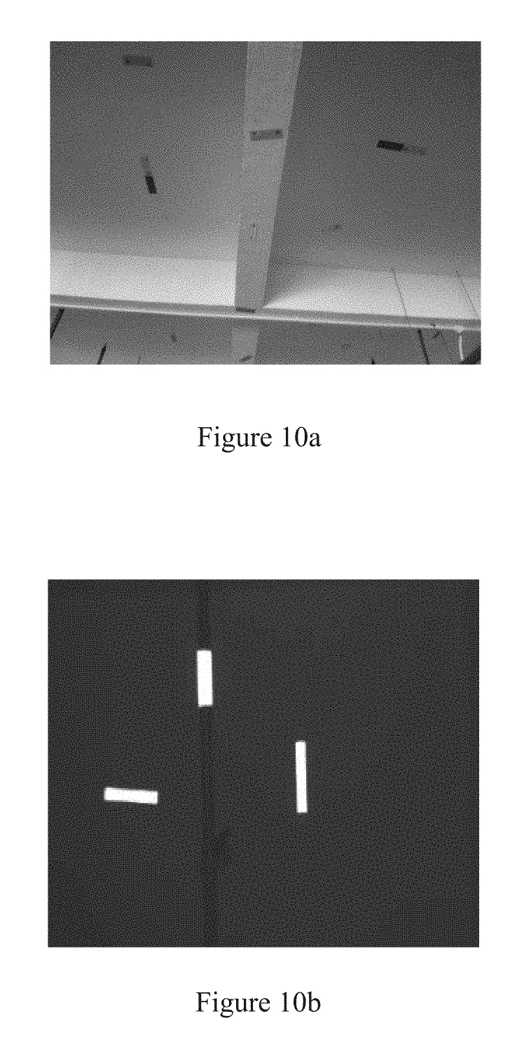

In an embodiment, and with reference to FIGS. 7-10b, the mobile robot is a forklift (seen in FIG. 7) or other wheeled, self-powered vehicle, and the navigation components are mounted on or near the top of the forklift, with a clear view of the ceiling, where the markers are to be located. If the markers are located on a side wall, for example, the navigation components would have a clear view of the side wall. As seen in FIG. 8, the navigation components consist primarily of a monochromatic light and a camera having a filter attuned to the monochromatic frequency. The location of the markers, for example the ceiling, has randomly placed reflective pieces to increase the signal to noise ratio of the signal received by the camera. The monochromatic light is projected on the ceiling and reflects from the reflective strips (shown in FIG. 9) on the ceiling, wherein the reflected signal is picked up by the camera component. The resulting image has a large amount of contrast as can be seen in FIGS. 10b, with reference to the reflective strip placement (seen with normal contrast and full range of visible light in FIG. 10a).

The above-mentioned represent some of the modes of implementation of the present invention and they are not intended to limit the scope of the invention. Any equivalent structure or process transformation made using the instructions and accompanying drawings of the present invention, or directly or indirectly applied to other related technical fields, is included within the scope of the patent protection of the present invention in the same way.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A method for identifying the position of a mobile robot by comparing images comprising:
illuminating a shooting area to be photographed using a monochromatic lighting unit;
capturing a position image corresponding to the shooting area through a camera;
acquiring a reference image corresponding to the trajectory of the mobile robot from a known position image set, the known position image set corresponding to a predetermined trajectory and including a plurality of reference images, the predetermined trajectory comprising a plurality of trajectory reference points;
comparing the position image with the reference image;
calculating the position of the trajectory reference points corresponding to the reference image relative to the shooting area of the position image to determine the trajectory position of the mobile robot; and
changing the trajectory of the mobile robot, in connection with moving the robot, so as to reduce the offset between the position image and the reference image.

2. The method of claim 1, wherein the mobile robot stores a set of known location images corresponding to a predetermined trajectory.

3. The method of claim 1, further comprising comparing the position image with the reference image and adjusting the position image based on the comparison result so that the position image is overlapped with the image shown in same area in the reference image, comprising the steps of:
comparing the position image with the reference image to obtain the same area between the position image and the reference image; and
moving and rotating the said position image with the trajectory reference point corresponding to the reference image as an origin so that the image in the same area of the position image overlaps with the image in the same area of the reference image.

4. The method of claim 3, further including calculating the distance between a position image relative to a reference trajectory point on the reference image.

5. The method of claim 1, wherein the reflective material or the light-absorbing material exists in a region in which the contrast ratio is relatively small in the shooting area corresponding to the predetermined trajectory.

6. The method of claim 1, further comprising:
judging whether the shooting area, corresponding to the position image, deviates from a predetermined trajectory in which the trajectory reference point corresponds to the reference image is located; and
if deviated, direct a path back within the preset trajectory and continuing the step of illuminating the shooting area to be photographed by the mobile robot using the monochrome lighting unit.

7. A mobile robot comprising:
a monochrome lighting module configured to illuminate the shooting area to be photographed;
a camera module configured to capture a position image corresponding to the shooting area, comprising a narrow band filter for passing light emitted by the camera module and the light of the same wavelength emitted by the camera module;
an image acquisition module configured to acquire a reference image corresponding to the trajectory of the mobile robot from the known position image set, wherein the known position image set corresponds to a predetermined trajectory and the known position image set includes a plurality of reference images, and wherein the predetermined trajectory is composed of a plurality of trajectory reference points and the referred reference images correspond to the referred trajectory reference points, and wherein the trajectory reference points corresponding to the reference images are closest to the shooting area corresponding to the position image;
a processing module configured to compare the position image with the reference image and adjusting the position image based on the comparison result so that the image in the same area of the position image overlaps with the image in the same area of the reference image; and
a calculation module configured to calculate a horizontal and vertical offset and an orientation of the trajectory reference point corresponding to the reference image corresponding to the position image to determine a trajectory position of the mobile robot.

8. The mobile robot of claim 7 further comprising:
an image storage module configured to store the known location image set corresponding to the predetermined trajectory;
a judgment module configured to judge whether the shooting area is corresponding to the position image deviates from a predetermined trajectory in which the trajectory reference point corresponding to the reference image is located; and
a correction module, configured to direct a path back within the predetermined trajectory when the judgment module determines that the shooting area corresponding to the position image deviates from a predetermined trajectory in which the trajectory reference point corresponding to the reference image is located.

9. The mobile robot of claim 7 the processing module further comprising:
a comparison acquisition unit configured to compared the position image with the reference image to obtain the same area between the position image and the reference image; and
an adjustment unit configured to move and rotate the position image with the trajectory reference point corresponding to the reference image as an origin so that the image in the same area of the position image overlaps with the image in the same area of the reference image;
the calculation module further comprises a calculation unit configured to calculate the distance between the position image and the y-axis relative to the x-axis moved by the two-dimensional coordinates of the origin and the angle at which the position image is rotated relative to the origin, and then obtains the position of the shooting area corresponding to the position image relative to the reference trajectory point of the reference image.

10. The mobile robot of claim 7 wherein the reflective material or the light-absorbing material exists in a region in which the contrast ratio is relatively small in the shooting area corresponding to the predetermined trajectory.
